(19) United States
(12) Patent Application Publication
(10) Pub. No.: US 2009/0023075 A1
(43) Pub. Date: Jan. 22, 2009

(54) Nonaqueous electrolyte including Diphenyl ether and lithium secondary battery using thereof

(76) Inventors: Jung Kang Oh, Uiwang-si (KR); Young Jai Cho, Uiwang-si (KR); Jeong Min Lee, Uiwang-si (KR); Hak Soo Kim, Uiwang-si (KR); Ho Seok Yang, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/216,691

(22) Filed: Jul. 9, 2008

Related U.S. Application Data
(63) Continuation of application No. PCT/KR2007/000170, filed on Jan. 9, 2007.

(30) Foreign Application Priority Data
Jan. 9, 2006 (KR) 10-2006-0002255

(51) Int. Cl. H01M 6/16; H01G 9/022; H02J 7/00

(52) U.S. Cl. 429/326; 252/62.2; 320/128

(57) ABSTRACT

A non-aqueous electrolyte for a lithium secondary battery includes a lithium salt, a basic organic solvent including a carbonate-based solvent, and a halogenated diphenyl ether compound represented by Formula 1:

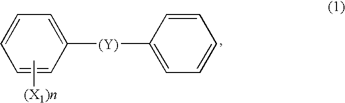

wherein Y is —O— or —R₁—OR₂—, where R₁ and R₂ are the same or different, and R₁ and R₂ are a C1-C5 alkyl group, an alkenyl group, or an alkoxy group, and only one of the phenyl rings is substituted with a halogen X₁, where n is equal to 1, 2, 3, or 4 and the halogens in di-, tri-, and tetra-halogen substitutions are the same or different.

This application is a continuation of pending International Application No. PCT Patent Application No. PCT/KR2007/000170, filed on Jan. 9, 2007, with the World Intellectual Property Organization, and entitled: “Nonaqueous Electrolyte Including Diphenyl Ether and Lithium Secondary Battery Using Thereof.”

### BACKGROUND OF THE INVENTION

1. Field of the Invention

Embodiments relate to a non-aqueous electrolyte including a halogenated diphenyl ether compound, and a lithium secondary battery including the non-aqueous electrolyte.

2. Description of the Related Art

Lithium secondary batteries may include an electrolyte having a non-aqueous solvent, i.e., an organic solvent, in which a lithium salt may be dissolved, disposed between positive and the negative electrodes. Lithium secondary batteries have a relatively high discharge voltage, e.g., about 3.6 to 3.7 V. To accommodate the high discharge voltage, the electrolyte should be electrochemically stable at a charge/discharge voltage ranging from 0 to 4.2 V. Further, the electrolyte should transfer ions at a high rate.

A carbonate-based organic solvent such as ethylene carbonate, dimethyl carbonate, or diethyl carbonate may be used as an organic solvent in the electrolyte. However, if the lithium secondary battery is overcharged, e.g., at a voltage of 4.2 V to 6 V or more, the organic solvent in contact with the positive electrode may initiate oxidative decomposition and generate undesired heat. The heat generation may lead to rupture or ignition of the battery, rendering the battery unstable. Accordingly, there is a need for an electrolyte that enables improved stability of a lithium secondary battery upon overcharging.

### SUMMARY OF THE INVENTION

Embodiments are therefore directed to a non-aqueous electrolyte including a halogenated diphenyl ether compound, and a lithium secondary battery including the non-aqueous electrolyte, which substantially overcome one or more of the problems due to the limitations and disadvantages of the related art.

It is therefore a feature of an embodiment to provide an electrolyte including a halogenated diphenyl ether compound in which only one ring is halogenated.

It is therefore another feature of an embodiment to provide a battery including an electrolyte having a halogenated diphenyl ether compound in which only one ring is halogenated.

At least one of the above and other features and advantages may be realized by providing a non-aqueous electrolyte for a lithium secondary battery, including a lithium salt, a basic organic solvent including a carbonate-based solvent, and a halogenated diphenyl ether compound represented by Formula 1:

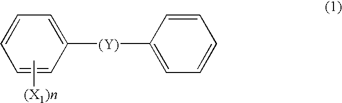

In Formula 1, Y may be —O— or —R₁—O—R₂—, where R₁ and R₂ may be the same or different, and R₁ and R₂ may be a C1-C5 alkyl group, an alkenyl group, or an alkoxy group, and only one of the phenyl rings is substituted with a halogen X₁, where n is equal to 1, 2, 3, or 4 and the halogens in di-, tri-, and tetra-halogen substitutions are the same or different.

One or both of the phenyl rings may be substituted with one or more substituents, the substituents may be the same or different, and the substituents may be a C1-C5 alkyl group, an alkenyl group, or an alkoxy group. The halogen X₁ may be chlorine or fluorine. The halogenated diphenyl ether compound may be chlorodiphenyl ether, fluorodiphenyl ether, bromodiphenyl ether, chlorophenyl benzyl ether, fluorophenyl benzyl ether, or a mixture thereof. The halogenated diphenyl ether compound may be used in an amount of about 0.1 to about 20 parts by weight, based on 100 parts by weight of the basic organic solvent. The halogenated diphenyl ether compound may be used in an amount of about 1 to about 10 parts by weight, based on 100 parts by weight of the basic organic solvent.

The basic organic solvent may be a mixture of a carbonate-based solvent and at least one of an ester-based solvent, an aromatic hydrocarbon-based solvent, or an ether-based solvent. The carbonate-based solvent may include at least one linear carbonate and at least one cyclic carbonate, the at least one linear carbonate may be dimethyl carbonate, diethyl carbonate, or methylethyl carbonate, and the at least one cyclic carbonate may be ethylene carbonate, propylene carbonate, or butylene carbonate.

The basic organic solvent may include the ester-based solvent, and the ester-based solvent may be γ-butyrolactone, decanolide, valerolactone, mevalonolactone, caprolactone, methyl acetate, ethyl acetate, n-propyl acetate, or a mixture thereof. The basic organic solvent may include the aromatic hydrocarbon-based solvent, and the aromatic hydrocarbon-based solvent may be fluorobenzene, 4-chlorotoluene, 4-fluorotoluene, or a mixture thereof. The basic organic solvent may include the ether-based solvent, and the ether-based solvent may be dimethyl ether, diethyl ether, dipropyl ether, dibutyl ether, or a mixture thereof.

The lithium salt may be LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₓF₂ₓ₊₁SO₂)(C_{y}F_{2y+1}SO₂) (where each of x and y is a positive integer), LiCl, LiI, or mixture thereof. The lithium salt may be used in a concentration of about 0.6 M to about 2.0 M, based on the basic organic solvent.

At least one of the above and other features and advantages may also be realized by providing a lithium secondary battery, including the non-aqueous electrolyte according to an embodiment, an electrode part including a positive electrode and a negative electrode disposed opposite to each other, and a separator electrically separating the positive electrode from the negative electrode.

A ratio of a charge capacity at −20° C. to a charge capacity at 20° C. may be 0.34 or more. The positive electrode may be coated with at least one active material, and the at least one active material may be LiCoO₂, LiMnO₂, LiMn₂O₄, LiNiO₂, or LiN_{1-x-y}CoₓM_{y}O₂ (where 0≦x≦1, 0≦y≦1, 0≦x+y≦1 and M is Al, Sr, Mg, or La). The negative electrode may be coated with at least one active material, and the at least one active material may be crystalline carbon, amorphous carbon, a carbon composite, a metal-carbon composite, a metal, a metal oxide, lithium metal, or a lithium alloy. The separator may be a polyethylene or polypropylene mono-layered separator, a polyethylene/polypropylene double-layered separator, a polyethylene/polypropylene/polyethylene triple-layered separator, or a polypropylene/polyethylene/polypropylene triple-layered separator.

At least one of the above and other features and advantages may also be realized by providing a method of powering a device, including providing power from the positive and negative electrodes of the battery according to an embodiment to power inputs of the device, and charging the battery.

At least one of the above and other features and advantages may also be realized by providing a method of making a non-aqueous electrolyte for a lithium secondary battery, the method including providing a lithium salt, providing a basic organic solvent including a carbonate-based solvent, providing a halogenated diphenyl ether compound represented by Formula 1:

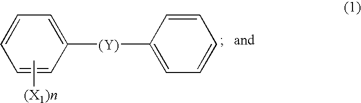

combining the lithium salt, the basic organic solvent, and the halogenated diphenyl ether compound. In Formula 1, Y may be —O— or —R₁—O—R₂—, where R₁ and R₂ may be the same or different, and R₁ and R₂ may be a C1-C5 alkyl group, an alkenyl group, or an alkoxy group, and only one of the phenyl rings may be substituted with a halogen X₁, where n is equal to 1, 2, 3, or 4 and the halogens in di-, tri-, and tetra-halogen substitutions are the same or different.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic diagram of a lithium secondary battery including a non-aqueous electrolyte according to an embodiment;

FIG. 2 illustrates a graph of a linear sweep voltammetry (LSV) measurement of an electrolyte according to an embodiment, the electrolyte containing 4-bromodiphenyl ether;

FIG. 3 illustrates a graph of an LSV measurement of an electrolyte according to an embodiment, the electrolyte containing 4-chlorodiphenyl ether;

FIG. 4 illustrates a graph comparing LSV measurements of electrolytes according to embodiments, the electrolytes respectively containing 4-chlorodiphenyl ether, 4-fluorodiphenyl ether, and 4-bromodiphenyl ether;

FIG. 5 illustrates a graph of an LSV measurement of an electrolyte containing diphenyl ether;

FIG. 6 illustrates a graph of an LSV measurement of an electrolyte containing biphenyl;

FIG. 7 illustrates a graph of an LSV measurement of an electrolyte containing cyclohexylbenzene;

FIG. 8 illustrates a graph of an LSV measurement of an electrolyte containing biphenyl and cyclohexylbenzene;

FIG. 9 illustrates a graph of an LSV measurement of an electrolyte containing no halogenated diphenyl ether compound;

FIGS. 10 to 15 illustrate graphs of measurements of voltage and current for batteries of Example 1, Example 5, and Comparative Examples 4 to 7, respectively, during overcharging;

FIG. 16 illustrates Table 1 showing component amounts for Examples 1 to 8 and Comparative Examples 1 to 7;

FIG. 17 illustrates Table 2 showing decomposition voltages for Example 1, Examples 5 to 8, and Comparative Examples 1 to 7;

FIG. 18 illustrates Table 3 showing performance characteristics of batteries for Examples 1 to 8 and Comparative Examples 4 to 7;

FIG. 19 illustrates Table 4 showing overcharging effects of batteries for Examples 1 to 8 and Comparative Examples 1 to 7; and

FIG. 20 illustrates Table 5 showing charge capacity ratios of batteries for Example 1, Examples 5 to 8, and Comparative Examples 1 to 3.

### DETAILED DESCRIPTION OF THE INVENTION

PCT Patent Application No. PCT/KR2007/000170, filed on Jan. 9, 2007, with the World Intellectual Property Organization, and entitled: “Nonaqueous Electrolyte Including Diphenyl Ether and Lithium Secondary Battery Using Thereof,” is incorporated by reference herein in its entirety.

Korean Patent Application No. 10-2006-0002255, filed on Jan. 9, 2006, in the Korean Intellectual Property Office, and entitled: “Nonaqueous Electrolyte Including Diphenyl Ether and Lithium Secondary Battery Using Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

As used herein, the terms “a” and “an” are open terms that may be used in conjunction with singular items or with plural items. For example, the term “a halogenated diphenyl ether compound” may represent a single compound, e.g., chlorodiphenyl ether, or multiple compounds in combination, e.g., chlorodiphenyl ether mixed with fluorodiphenyl ether.

An embodiment provides a non-aqueous electrolyte for a lithium secondary battery. The non-aqueous electrolyte may include a lithium salt, a basic organic solvent including a carbonate-based solvent, and a halogenated diphenyl ether compound, which may enable stabilization of the lithium secondary battery at an overcharge voltage of 4.2 V or more. The halogenated diphenyl ether compound may be a single compound or multiple compounds, e.g., the halogenated diphenyl ether compound may be a mixture of chlorodiphenyl ether with fluorodiphenyl ether.

The halogenated diphenyl ether compound may be represented by the following Formula 1:

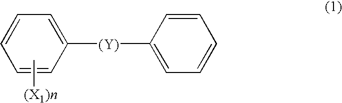

In Formula 1, Y may be —O—, i.e., a direct ether linkage. In another implementation, Y may be —R₁—O—R₂—, where R₁ and R₂ are the same or different. R₁ and R₂ may be, e.g., a C1-C5 alkyl group, an alkenyl group, or an alkoxy group. For example, the halogenated diphenyl ether compound may be 4-fluorodiphenyl ether in the case that Y is —O—, or may be 4-fluorodibenzyl ether in the case that Y is —R₁—O—R₂— and R₁ and R₂ the same, e.g., each is a same C1-C5 alkyl group such as methylene, i.e., —CH₂—. Further, the halogenated diphenyl ether compound may be 4-fluorophenyl benzyl ether in the case that Y is —R₁—O—R₂—, and R₁ and R₂ are different.

In Formula 1, only one of the phenyl rings may be substituted with a halogen X₁, where n is equal to 1, 2, 3, or 4 and the halogens in di-, tri-, and tetra-halogen substitutions are the same or different. For example, the halogenated diphenyl ether compound may be 3,4-difluorodiphenyl ether in the case that the di-halogen substitutions are the same, or may be 3-chloro-4-fluorophenyl ether in the case that the di-halogen substitutions are different.

In Formula 1, one or both of the phenyl rings may be substituted with one or more substituents. The substituents may be the same or different, and may be, e.g., a C1-C5 alkyl group, an alkenyl group, or an alkoxy group. For example, the halogenated diphenyl ether compound may be 3-methyl-4-fluoro-4′-ethyldiphenyl ether in the case that the substituents are each a same group, e.g., a C1-C5 alkyl group such as methyl.

The non-aqueous electrolyte may enable an improvement in life cycle and high-temperature properties, as well as stability of a lithium secondary battery upon overcharging. Without being bound by theory, it is believed that the benefits of the non-aqueous electrolyte according to an embodiment are based on the following mechanism.

The non-aqueous electrolyte includes, as an additive, a halogenated diphenyl ether compound in which only one phenyl group is substituted with halogen. As will be illustrated in the following Examples, the halogenated diphenyl ether compound undergoes oxidative decomposition at a relatively high voltage of about 4.50 to 4.60 V and leaves a deposit on the surface of a positive electrode. The oxidative decomposition at the relatively high voltage of about 4.50 to 4.60 V is lower than 6 V, at which the basic organic solvent initiates oxidative decomposition.

Accordingly, upon overcharging of a lithium secondary battery, the additive undergoes oxidative decomposition prior to the basic organic solvent, and leaves a deposit of a resulting product on a positive electrode, thereby preventing the basic organic solvent from being oxidized and decomposed, and ensuring stability of the lithium secondary battery.

Upon high-rate overcharging, e.g., the application of a charge capacity C of two or more times than that of the lithium secondary battery, the basic organic solvent is believed to undergo oxidative decomposition. Such oxidative decomposition may occur even at a voltage lower than 6 V, e.g., about 4.70 V, to generate undesired heat. In addition, diphenyl ether compounds having both phenyl groups substituted with halogen may initiate oxidative composition and deposition at a voltage higher than 4.70 V. Accordingly, when such a diphenyl ether compound is used, the basic organic solvent initiates oxidative decomposition upon high-rate overcharging to generate undesired heat prior to the diphenyl ether compound having both rings halogenated. In contrast, the halogenated diphenyl ether compound according to an embodiment, e.g., as shown in Formula 1, undergoes oxidative decomposition and leaves a deposit on a positive electrode at a voltage of about 4.50 to 4.60 V. That is, even upon high-rate overcharging, oxidative decomposition of the compound of Formula 1 may occur prior to decomposition of the basic organic solvent. As a result, oxidative decomposition of the basic organic solvent may be inhibited. Hence, it may be possible to ensure stability of the lithium secondary battery even upon high-rate overcharging though the use of the non-aqueous electrolyte according to an embodiment, in which the halogenated diphenyl ether compound of the Formula 1 is contained as an additive. The halogenated diphenyl ether compound enables the lithium secondary battery to exhibit sufficient stability upon overcharging or even high-rate overcharging.

The halogenated diphenyl ether compound of Formula 1 may undergo oxidative decomposition at a relatively high voltage of about 4.50 to 4.60 V, and at a relatively high temperature corresponding to the voltage. For this reason, even if the lithium secondary battery is stored under the conditions of a high temperature or is partly exposed to high voltage, i.e., about 4.4 V, during a normal operation (normal operation being a driving voltage of 4.2 V or less), oxidative decomposition and deposition of the additive may be decreased. As a result, during use of the lithium secondary battery over a long period, a reduction in content of the additive, and a decrease in the battery capacity due to deposition of the additive, may be lowered. This may enable improvement in life cycle and high-temperature properties of the lithium secondary battery.

In addition, the halogenated diphenyl ether compound of Formula 1, where hydrogen of only one phenyl group is substituted by halogen, may have a viscosity lower than other diphenyl ether compounds having both phenyl groups substituted with halogen. Further, the halogenated diphenyl ether compound of Formula 1 may not undergo rapid variation of the viscosity at a low temperature. For this reason, the use of the compound of Formula 1 as an additive may enable the lithium secondary battery to continuously exhibit a high charge capacity, even at a low temperature, e.g., −20° C. or less. As a result, low-temperature property of the lithium secondary battery may be improved.

Hereinafter, constituent components of the non-aqueous electrolyte will be described in detail.

First, the non-aqueous electrolyte may include a basic organic solvent including a carbonate-based solvent. The basic organic solvent may include only the carbonate-based solvent, or may include a mixture of the carbonate-based solvent with, e.g., an ester-based solvent, aromatic hydrocarbon-based solvent, or an ether-based solvent.

More specifically, examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), fluoroethylene carbonate (FEC), vinylene carbonate (VC), and vinylethylene carbonate (VEC).

Examples of the ester-based solvent include y-butyrolactone (BL), decanolide, valerolactone, mevalonolactone, caprolactone, methyl acetate, ethyl acetate, and n-propyl acetate. Examples of the ether-based solvent include dimethyl ether, diethyl ether, dipropyl ether, and dibutyl ether.

Examples of the aromatic hydrocarbon-based solvent include fluorobenzene, 4-chlorotoluene (4CT), and 4-fluorotoluene (4CT).

The non-aqueous organic solvent may be used singly, or as a mixture of two or more solvents thereof.

Preferably, the basic organic solvent contained in the non-aqueous organic solvent includes at least one of the following linear carbonates: dimethyl carbonate (DMC), diethyl carbonate (DEC), and methylethyl carbonate (MEC), and further includes at least one of the following cyclic carbonates: ethylene carbonate (EC), propylene carbonate (PC), and butylene carbonate (BC).

The cyclic carbonate-based solvent may sufficiently dissolve lithium ions owing to its high polarity, but may exhibit a low ion-conductivity due to its high viscosity. Therefore, the use of a mixed solvent of cyclic carbonate and linear carbonate having a low polarity and a low viscosity, as a basic organic solvent of the non-aqueous electrolyte, may provide optimal properties for the lithium secondary battery.

The non-aqueous electrolyte may further include a lithium salt as a solute. The lithium salt may be, e.g., LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂ LiN(CₓF₂ₓ₊₁SO₂)(C_{y}F_{2y+1}SO₂) (wherein, each of x and y is a positive integer), LiCl, or LiI, or a mixture of the lithium salts.

The lithium salt may be used in a concentration of about 0.6 to about 2.0 M, preferably about 0.7 to about 1.6 M, with respect to the basic organic solvent. The use of the lithium salt in a concentration less than 0.6 M may result in deterioration in electrical conductivity of the non-aqueous electrolyte that contains the lithium salt, thus leading to deterioration in the capability to transmit ions between a positive electrode and a negative electrode at a high rate. The use of the lithium salt in a concentration exceeding 2.0 M may cause an increase in viscosity of the non-aqueous electrolyte, thus disadvantageously leading to a reduction in the mobility of lithium ions, and reducing performance of the battery at low-temperature.

The non-aqueous electrolyte, in addition to the basic organic solvent and lithium salt, may include an additive containing the halogenated diphenyl ether compound of Formula 1.

The halogenated diphenyl ether compound of Formula 1 may have a structure in which hydrogen of one phenyl group is substituted with halogen. The halogen substituent is preferably chlorine or fluorine. As will be illustrated in the following Examples, the halogenated diphenyl ether compound of Formula 1 containing chlorine or fluorine exhibits a high reactivity at an oxidative decomposition voltage of 4.5 to 4.6 V, as compared to other halogenated diphenyl ether compounds containing a substituent selected from halogens other than chlorine and fluorine, e.g., bromine. Thus, the halogenated diphenyl ether compound of Formula 1 containing a substituent of chlorine or fluorine as an additive rapidly undergoes oxidative decomposition at a voltage of about 4.50 V or more, prior to the basic organic solvent, and leaves plenty of deposits on the positive electrode, thereby preventing oxidative decomposition of the basic organic solvent and an occurrence of undesired heat. As a result, stability of the lithium secondary battery upon overcharging may be enhanced.

The halogenated diphenyl ether compound of Formula 1 may be, e.g., a monosubstituted halogenated diphenyl ether such as chlorodiphenyl ether, fluorodiphenyl ether, bromodiphenyl ether, chlorophenyl benzyl ether, fluorophenyl benzylether, or a mixture thereof. In an implementation, the additive may further include one or more of biphenyl, cyclohexylbenzene, chlorotoluene, or fluorotoluene.

The halogenated diphenyl ether compound is preferably used in an amount of about 0.1 to about 10 parts by weight, more preferably about 1 to about 10 parts by weight, based on 100 parts by weight of the basic organic solvent. The use of the halogenated diphenyl ether compound in an amount less than about 0.1 parts by weight may make it difficult to bring the stability, life cycle property, and high-temperature property of the lithium secondary battery to the desired level. The use of the halogenated diphenyl ether compound in an amount exceeding about 10 parts by weight may cause a deterioration in the life cycle property of the lithium secondary battery.

Hereinafter, effects of the non-aqueous electrolyte having the halogenated diphenyl ether compound of Formula 1 contained therein will be described in greater detail.

A major problem in operation of a lithium secondary battery at a normal operation voltage (i.e., 4.3 V or less) is oxidative decomposition due to a negative electrode being in contact with an electrolyte, gas generation due to the oxidative decomposition, and an increase in internal pressure of the battery. In an attempt to prevent the negative electrode from reacting with the electrolyte, a coating may be formed on the negative electrode. However, upon overcharging or under a high temperature, the organic solvent contained in the electrolyte may undergo active oxidative decomposition on the surface of a positive electrode, thus causing an occurrence of undesired heat and an increase in internal pressure of the battery.

In an effort to solve these problems, the non-aqueous electrolyte according to an embodiment includes the halogenated diphenyl ether compound, which may undergo oxidative decomposition at a voltage of about 4.5 to 4.6 V, i.e., at a voltage less than the 6 V voltage at which the organic solvent initiates oxidative decomposition. Upon overcharging, the additive may undergo oxidative decomposition prior to the organic solvent, generating gas and leaving a deposit of a resulting product on the surface of the positive electrode.

The deposited resulting product enables formation of a coating, i.e., a passivation layer, on the positive electrode surface, thereby preventing the organic solvent in the non-aqueous electrolyte from undergoing oxidative decomposition. In particular, the coating acts as an overcharge inhibitor, since it is largely resistant to redissolution in the electrolyte. Therefore, the inclusion of the halogenated diphenyl ether compound as an additive in the non-aqueous electrolyte according to an embodiment may cause a reduction in heat generation upon overcharging, thereby preventing thermal runaway and enhancing stability of the battery.

Upon high-rate overcharging, e.g., where a charge capacity C of two times or more than that of the lithium secondary battery is applied, the basic organic solvent may undergo oxidative composition and generate undesired heat, even at a voltage lower than 6 V, e.g., 4.70 V. The halogenated diphenyl ether compound of Formula 1 undergoes oxidative composition and deposition at a voltage of about 4.50 to 4.60 V, i.e., lower than 4.70 V. Accordingly, even upon high-rate overcharging, the halogenated diphenyl ether compound undergoes oxidative decomposition prior to the basic organic solvent, and leaves a deposit of the resulting product on the positive electrode. Hence, upon high-rate overcharging of the lithium secondary battery, the halogenated diphenyl ether compound contained in the electrolyte according to an embodiment may inhibit both oxidative decomposition of the basic organic solvent and the occurrence of undesired heat, thereby ensuring more improved stability. Accordingly, the use of the non-aqueous electrolyte comprising the halogenated diphenyl ether compound as an additive according to an embodiment enables the lithium secondary battery to exhibit sufficient stability upon overcharging, particularly, even upon high-rate overcharging.

The halogenated diphenyl ether compound undergoes oxidative decomposition at a relatively high voltage of about 4.50 to 4.60 V and at a relatively high temperature corresponding to the voltage. For this reason, even if the lithium secondary battery is stored under the conditions of a high temperature or is partly exposed to high voltage (i.e., about 4.4 V) during a operation at a normal voltage of 4.2 V or less, oxidative decomposition and deposition of the additive can be reduced. As a result, during use of the lithium secondary battery even for a long period, a reduction in content of the additive and a decrease in the battery capacity due to the additive deposition can be lowered. This enables an improvement in life cycle and high-temperature properties of the lithium secondary battery.

In addition, the halogenated diphenyl ether compound of Formula 1 has a relatively low viscosity, and undergoes no rapid variation in viscosity at a low temperature. For this reason, the use of the compound of Formula 1 as an additive enables a high charge capacity of the lithium secondary battery to maintain even at a low temperature of −20° C. or less. As a result, low-temperature property of the lithium secondary battery can be improved more effectively.

The non-aqueous electrolyte may be stable at a temperature ranging from about −20° C. to about 60° C., and may remain stable even at a voltage of 4 V, thereby improving stability and reliability of the lithium secondary battery. Thus, the non-aqueous electrolyte may be applied to a wide variety of lithium secondary batteries, e.g., lithium ion batteries, lithium polymer batteries, etc.

According to another embodiment, there is provided a lithium secondary battery comprising the non-aqueous electrolyte described above. The lithium secondary battery may further include an electrode part having a positive electrode and a negative electrode that face each other at opposite sides of the non-aqueous electrolyte, and a separator electrically separating the positive electrode from the negative electrode.

The lithium secondary battery exhibits considerable stability upon overcharging, particularly, even upon high-rate overcharging, as well as improved high-temperature property and life cycle property, owing to the effects of the non-aqueous electrolyte. Furthermore, the lithium secondary battery has a relatively high charge capacity at a low temperature of about −20° C. or less, thus having improved low-temperature property. For example, a ratio of a charge capacity at −20° C. to a charge capacity at 20° C. of the lithium secondary battery may be about 0.34 or more.

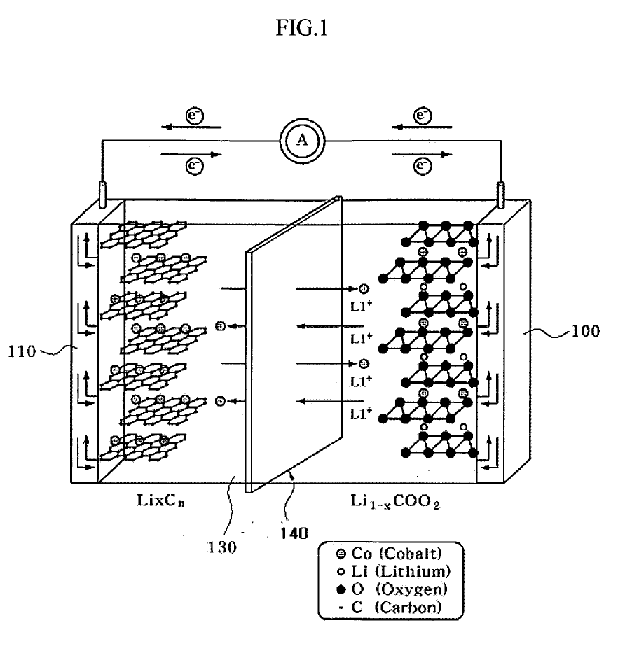

FIG. 1 illustrates a schematic diagram of a lithium secondary battery including a non-aqueous electrolyte according to an embodiment. Referring to FIG. 1, the lithium secondary battery may use LiCoO₂ as an active material of a positive electrode 100, carbon (C) may be used as an active material of a negative electrode 110, and the non-aqueous electrolyte according to an embodiment may be used as an electrolyte 130.

As shown in FIG. 1, the lithium secondary battery includes the positive electrode 100, the negative electrode 110, the electrolyte 130, and the separator 140.

The positive electrode 100 may be made of a positive active material-coated metal, e.g., aluminum) Although LiCoO₂ is used as the positive active material in the lithium secondary battery shown in FIG. 1, the positive active material may be, e.g., LiCoO₂, LiMnO₂, LiMn₂O₄, LiNiO₂, LiN_{1-x-y}CoₓM_{y}O₂ (where 0≦x≦1, 0≦y≦1, 0≦x+y≦1, and M is Al, Sr, Mg, or La), a lithium intercalation compound such as lithium chalcogenide, or another suitable positive active material.

The negative electrode 110 may be made of a negative active material-coated metal, e.g., copper. Although carbon, such as crystalline or amorphous carbon, is used as the negative active material in the lithium secondary battery of FIG. 1, the negative active material may also be, e.g. a metal, metal oxide, lithium metal, a lithium alloy, a carbon composite, or a metal-carbon composite, each exhibiting reversible lithium intercalation/deintercalation.

The metal used for the positive electrode 100 and the negative electrode 110 receives a voltage from an external source during charging, and supplies the voltage to the outside during discharging. The positive active material serves to collect positive charges, and the negative active material serves to collect negative charges.

The separator 140 electrically separates the positive electrode 100 from the negative electrode 110. The separator 140 may be, e.g., a polyethylene or polypropylene mono-layered separator, a polyethylene/polypropylene double-layered separator, a polyethylene/polypropylene/polyethylene or polypropylene/polyethylene/polypropylene triple-layered separator, etc.

The following Examples and Comparative Examples are provided in order to set forth particular details of one or more embodiments. However, it will be understood that the embodiments are not limited to the particular details described.

### EXAMPLES

### Examples 1 to 8 and Comparative Examples 1 to 7

LiCoO₂ as a positive active material, polyvinylidene fluoride (PVDF) as a binder, and carbon as a conductive agent were mixed at a weight ratio of 92:4:4. Then, the mixture was dispersed in N-methyl-2-pyrrolidone to prepare a positive electrode slurry. The slurry was coated on an aluminum foil having a thickness of 20 μm, followed by drying and compressing, to manufacture a positive electrode.

Artificial crystalline graphite as a negative active material and polyvinylidene fluoride (PVDF) as a binder were mixed at a weight ratio of 92:8. Then, the mixture was dispersed in N-methyl-2-pyrrolidone to prepare a negative electrode slurry. The slurry was coated on a copper foil having a thickness of 15 μm, followed by drying and compressing, to manufacture a negative electrode.

The resulting positive and negative electrodes were wound and pressed together with a polyethylene separator having a thickness of 16 μm, and placed into a prismatic can having the dimensions of 30 mm×48 mm×6 mm. 1 M LiPF₆ as a lithium salt was added to a mixed solvent of ethylene carbonate (EC) and ethylmethyl carbonate (EMC) (volume ratio of 1:2) to prepare a basic electrolyte.

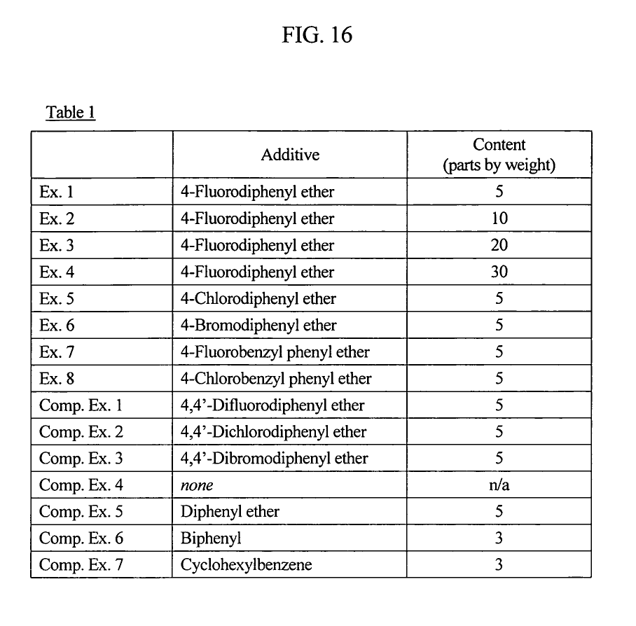

As shown in Table 1 in FIG. 16, additives were added to the basic electrolyte to prepare respective non-aqueous electrolytes. Each electrolyte was injected into an inlet of a respective prismatic can, which was then sealed, to manufacture a rectangular battery. In Table 1, the content of the additive is in parts by weight with respect to 100 parts by weight of the basic electrolyte.

The decomposition-initiating voltage of each non-aqueous electrolyte prepared in Examples 1, 5, 6, 7 and 8, and Comparative Examples 1 to 7 was measured by linear sweep voltammetry (LSV). The results are shown in Table 1. The measurement of the decomposition-initiating voltage was carried out under the following conditions: working electrode: Pt; reference electrode: Li-metal; counter electrode: Li-metal; voltage range: 3 to 7 V; and scan rate: 0.1 mV/s.

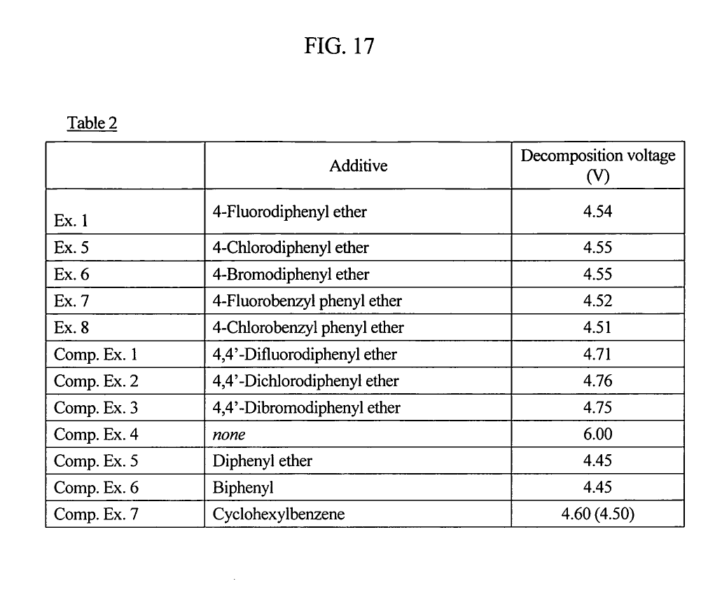

As can be seen from the data of Table 2 in FIG. 17, the additives used in Examples 1, 5, 6, 7 and 8, which are halogenated diphenyl ether compound of the Formula 1, initiated oxidative decomposition at a voltage of about 4.50V to about 4.60 V. The oxidative decomposition voltage of about 4.50 V to about 4.60 V was lower than decomposition-initiating voltage of the basic organic solvent, which is about 6 V. Accordingly, upon overcharging of the lithium secondary battery, the additives used in Examples 1, 5, 6, 7 and 8 would undergo oxidative decomposition prior to the basic organic solvent. The oxidative decomposition of the additive leads to formation of a coating on a positive electrode. The coating prevents the basic organic solvent from undergoing oxidative decomposition, thus avoiding gas generation resulted from oxidative decomposition. As a result, the internal pressure of the battery is reduced, and the thickness of the battery is prevented from increasing after full-charging. Hence, it is possible to ensure stability of the lithium secondary battery upon overcharging.

On the other hand, the additives of other diphenyl ether compounds used in Comparative Examples 1 to 3, in which hydrogen of both phenyl groups is substituted by halogen, initiated oxidative decomposition at a voltage of 4.70 V or more, which is higher than that of the additive each used in Examples 1, 5, 6, 7 and 8. However, upon high-rate overcharging, to which a charge capacity C of two times or more than that of the lithium secondary battery is applied, the basic organic solvent would undergo oxidative composition and generate undesired heat, even at a relatively low voltage of 4.70 V. Accordingly, in a case where each additive of Comparative Examples 1 to 3 is used, the organic solvent may undergo oxidative decomposition prior to the additive to generate the undesired gas and heat upon high-rate overcharging, thus making it impossible to ensure stability of the lithium secondary battery to a desired level upon the high-rate overcharging.

The diphenyl ether, biphenyl, and cyclohexylbenzene used as additives in Comparative Examples 5 to 7 may be expected to initiate oxidative decomposition at a voltage lower than that of the basic organic solvent and contribute to ensuring stability in overcharging. However, it was confirmed that these additives of the Comparative Examples may initiate oxidative decomposition at a low voltage, e.g., of 4.45 V or less, and leave a deposit of the resulting product on the surface of a positive electrode.

Even if the lithium secondary battery, to which each additive in Comparative Examples 5 to 7 is applied, is operated at a normal driving voltage, if the battery is stored at a high temperature or is partly exposed to a high voltage, the additive undergoes oxidative decomposition and continuously leaves a deposit of the resulting product on the positive electrode. Accordingly, the use of the lithium secondary battery for a long time results in a continuous reduction in content of the additive, thus making it difficult to ensure stability to the desired level upon overcharging. Furthermore, even under normal conditions, continuous deposition of the product resulting from decomposition of the additive causes a large decrease in capacity of the secondary battery corresponding to the deposition, deteriorating life cycle and high-temperature properties.

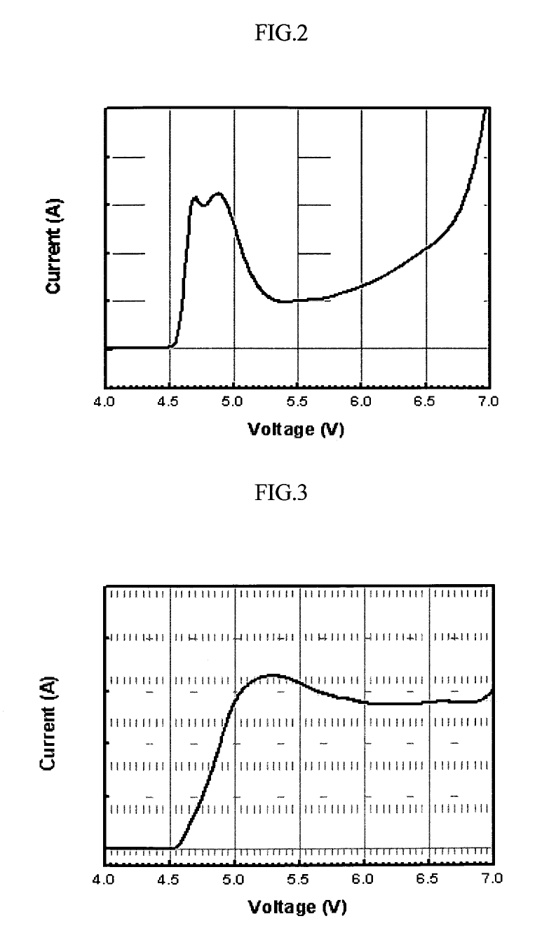

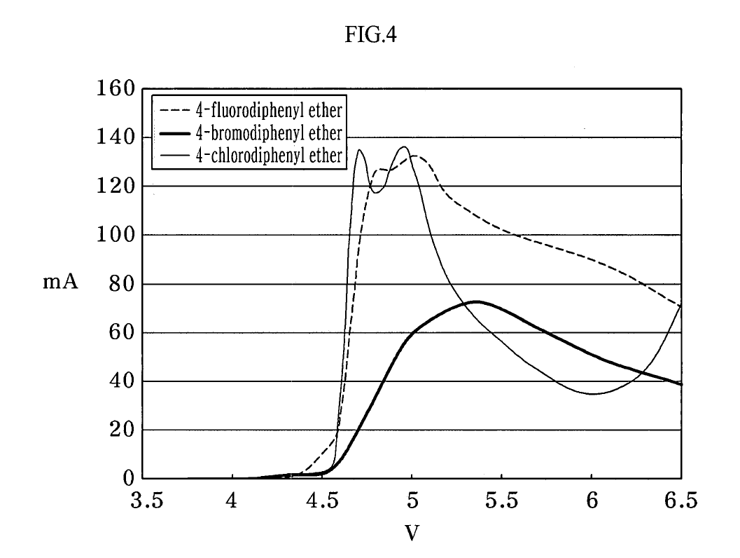

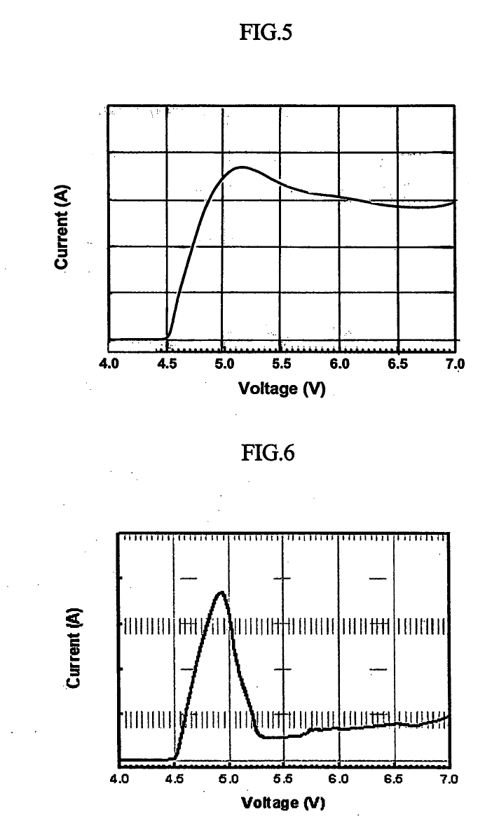

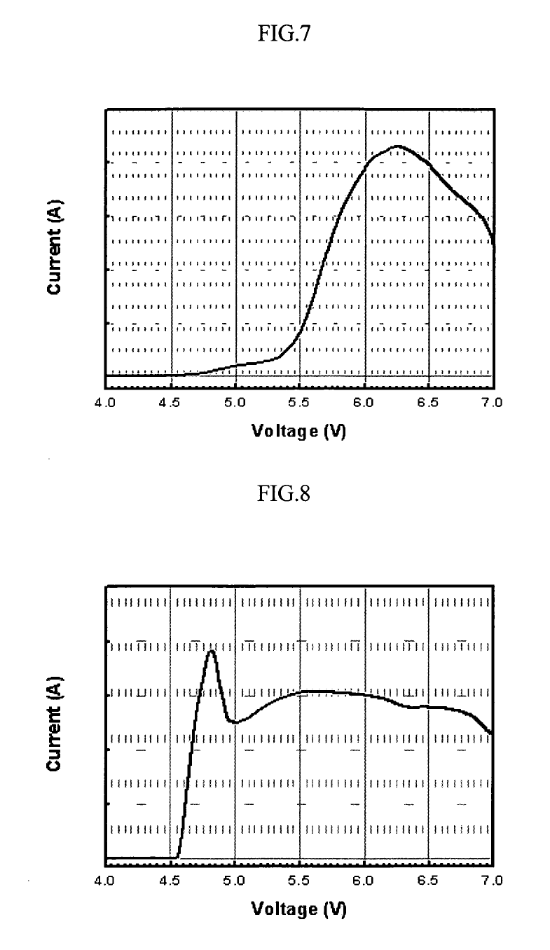

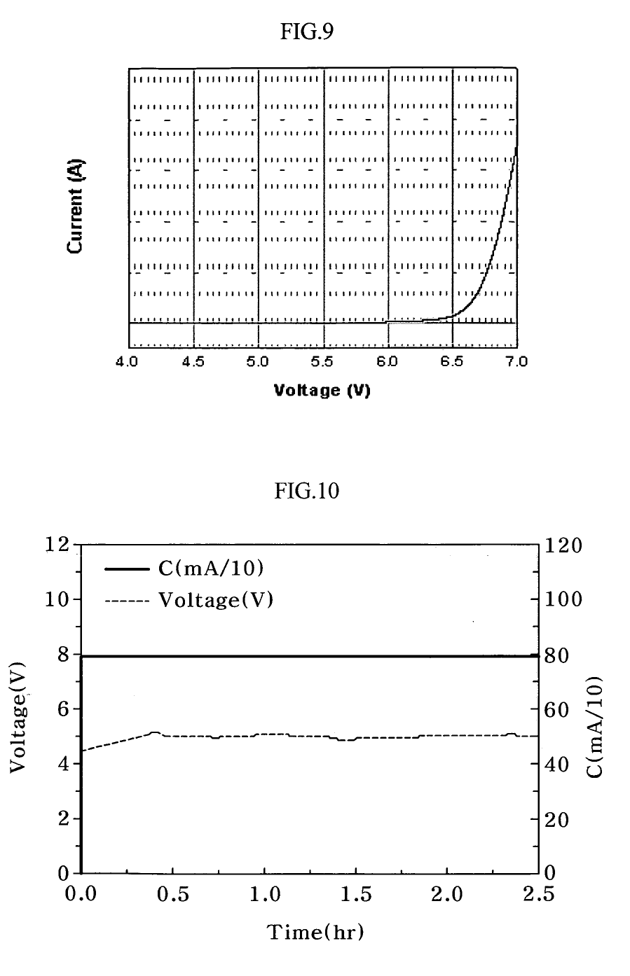

FIG. 2 illustrates a graph of a linear sweep voltammetry (LSV) measurement of an electrolyte according to an embodiment, the electrolyte containing 4-bromodiphenyl ether, FIG. 3 illustrates a graph of an LSV measurement of an electrolyte according to an embodiment, the electrolyte containing 4-chlorodiphenyl ether, FIG. 4 illustrates a graph comparing LSV measurements of electrolytes according to embodiments, the electrolytes respectively containing 4-chlorodiphenyl ether, 4-fluorodiphenyl ether, and 4-bromodiphenyl ether, FIG. 5 illustrates a graph of an LSV measurement of an electrolyte containing diphenyl ether, FIG. 6 illustrates a graph of an LSV measurement of an electrolyte containing biphenyl, FIG. 7 illustrates a graph of an LSV measurement of an electrolyte containing cyclohexylbenzene, FIG. 8 illustrates a graph of an LSV measurement of an electrolyte containing biphenyl and cyclohexylbenzene, and FIG. 9 illustrates a graph of an LSV measurement of an electrolyte containing no halogenated diphenyl ether compound.

As shown in FIGS. 2 to 4, the electrolytes containing 4-chlorodiphenyl ether, 4-fluorodiphenyl ether, and 4-bromodiphenyl ether as an additive had an oxidation voltage of 4.54 to 4.55 V, which is considerably lower than that of the basic electrolyte (a mixture of a EC/EMC (1:2, v/v) solvent and 1 M LiPF₆) containing no additive.

When 4-chlorodiphenyl ether, 4-fluorodiphenyl ether, or 4-bromodiphenyl ether is added to the non-aqueous electrolyte, the additive undergoes oxidization prior to the electrolyte to form a coating on the positive electrode, thereby inhibiting the electrolyte from being decomposed, and improving stability of the lithium secondary battery.

When 4-chlorodiphenyl ether, 4-fluorodiphenyl ether, or 4-bromodiphenyl ether is used as an additive, an oxidation product is deposited on the positive electrode in the form of a black tar at a voltage higher than the oxidation voltage. Thus, the oxidation product is coated and deposited on the positive electrode. When a voltage higher than the oxidation voltage is applied, the oxidation continuously occurs, thereby causing a rapid increase of the product deposited on the surface of the positive electrode and a continuous current consumption during overcharging of the lithium secondary battery, preventing the electrolyte from being decomposed and ensuring stability of the battery.

Referring to FIG. 4, it could be confirmed that among these halogenated diphenyl ethers, 4-chlorodiphenyl ether having a chlorine substituent and 4-fluorodiphenyl ether having a fluorine substituent have a high reactivity at an oxidation voltage or higher voltage, as compared to 4-bromodiphenyl ether. Accordingly, 4-chlorodiphenyl ether and 4-fluorodiphenyl ether undergo oxidation decomposition more rapidly, and thus leave a coating and a deposit of the oxidation product on the positive electrode surface at a high rate, as compared to the case of 4-bromodiphenyl ether. As a result, 4-chlorodiphenyl ether and 4-fluorodiphenyl ether are preferred for improving stability of the lithium secondary battery more efficiently.

### Evaluation for Variation in Thickness and Life Cycle of Battery After Charging

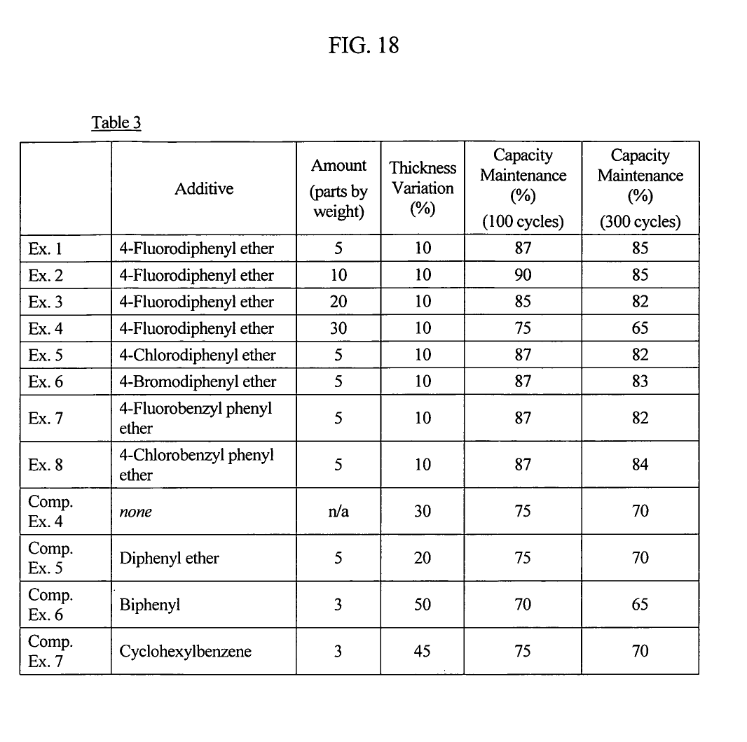

The lithium secondary batteries manufactured by injecting electrolytes of Examples 1 to 8 and Comparative Example 4 to 7 were charged with an electric current of 166 mA to a charge voltage of 4.2 V under the conditions of CC-CV (constant current-constant voltage), and left for 1 hour. Then, batteries were discharged with an electric current of 166 mA to a discharge voltage of 2.75 V, and left for 1 hour. After repeating a series of charging and discharging three times, the batteries were charged with an electric current of 780 mA to a charge voltage of 4.2 V for 2.5 hours. The batteries were put in a high-temperature chamber of 85° C. and left for 4 days. Variation of the thickness of each battery (comparing the thickness measured upon initial assembly to the thickness measured after charging) was evaluated. The results are shown in Table 3 in FIG. 18.

The lithium secondary batteries manufactured by injecting electrolytes of Examples 1 to 8 and Comparative Example 4 to 7 were charged with 1 C to a charge voltage of 4.2 V under the conditions of CC-CV, and discharged with 1 C to a cut-off voltage of 3 V under the conditions of CC. After repeating the charging and discharging 100 and 300 times, the maintenance ratio in capacity of batteries, i.e., the ratio of a remaining capacity to an initial capacity, was calculated. The results are shown in Table 3 in FIG. 18.

As shown by the data of Table 3, the batteries of Examples 1 to 8 exhibited only a slight increase in thickness and only a slight decrease in capacity, thus exhibiting improved high-temperature and life cycle properties as compared to Comparative Examples 4 to 7.

Biphenyl and cyclohexylbenzene, used in Comparative Examples 4 to 7, are decomposed even at a relatively low voltage. Even where a battery is operated at a normal driving voltage, if the battery is stored at a high temperature or is partly exposed to a high voltage, the resulting decomposition product is continuously deposited on the surface of a positive electrode. This causes a great decrease in capacity of the secondary battery as a result of the deposition.

### Evaluation for Overcharge Characteristics of Battery

FIGS. 10 to 15 illustrate graphs of measurements of voltage and current for batteries of Example 1, Example 5, and Comparative Examples 4 to 7, respectively, during overcharging, in which the batteries were each overcharged with an electric current of 780 mA for 2.5 hours in a 4.2 V full-charged state.

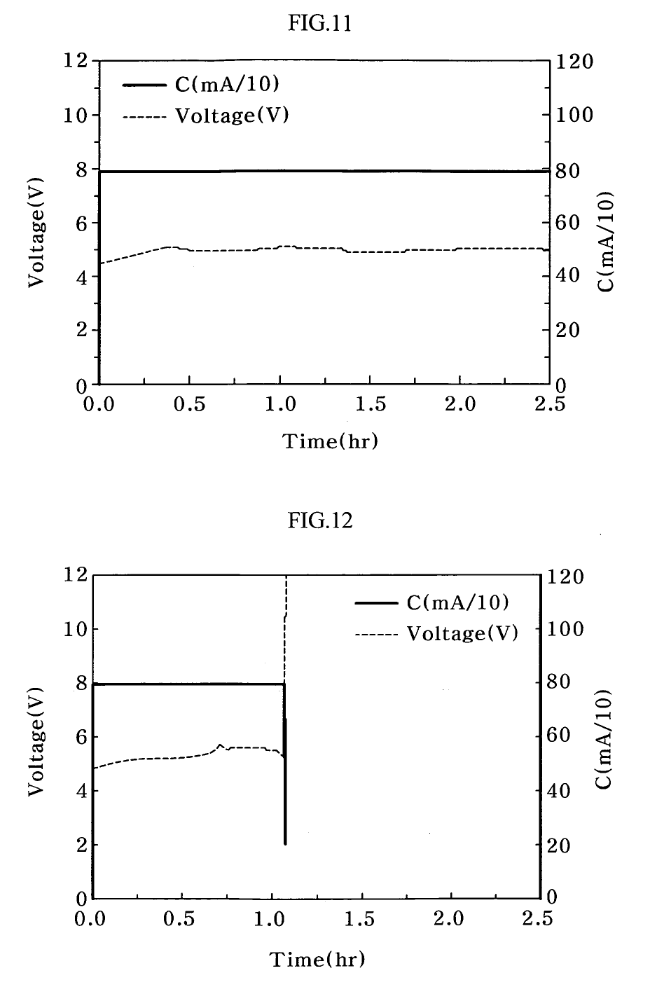

As shown in FIG. 10, in a case of Example 1, after charging to 4.2 V and overcharging of the battery, 4-fluorodiphenyl ether initiates decomposition at a voltage of 4.5 to 4.6 V. As a result, the voltage of the battery elevates to 5.3 V and then decreases to 5.2 V. As shown in FIG. 11, 4-chlorodiphenyl ether (Example 5) initiates decomposition at a voltage of 4.5 to 4.6 V. As a result, the voltage of the battery elevates to 5.1 V and decreases to 5.0 V. The variation in voltage is based on a polymerization product deposited on a positive electrode and polymerization heat by polymerization derived from oxidation of 4-fluorodiphenyl ether and 4-chlorodiphenyl ether.

The heat generation causes shut-down of the electrode separator. After further overcharging, a conductive product is deposited in fine pores where no shut-down has occurred. The deposition causes a fine short-circuit between the positive electrode and the negative electrode, thereby allowing a current to flow and leading to a further increase in voltage. After reaching a critical temperature, the temperature stabilizes without further increase.

The lithium secondary batteries of Examples 1 and 5, to which the halogenated diphenyl ether compound is applied, induce an internal short-circuit and undergo no increase in voltage, thus preventing heat explosion upon overcharging, in spite of continuous current application. However, the batteries allow a voltage drop to occur when not charging. Accordingly, the lithium secondary batteries of Examples 1 and 5 are more stable than that of comparative Example 4, to which the halogenated diphenyl ether compound was not applied.

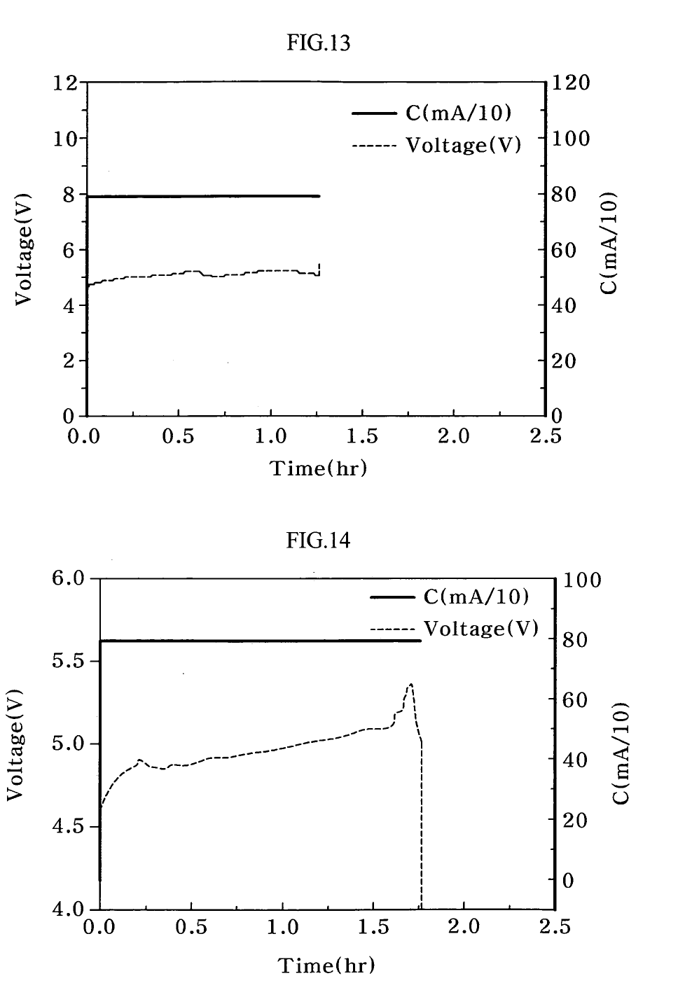

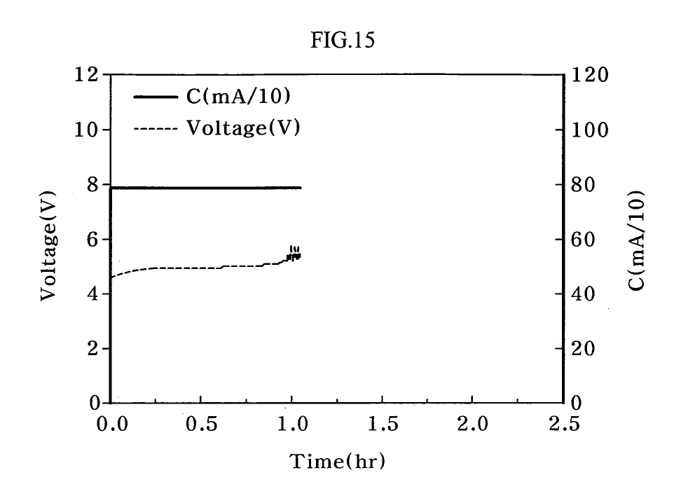

Referring to FIGS. 14 and 15, it can be seen that the use of biphenyl or cyclohexylbenzene made it difficult to ensure stability upon overcharging. Referring to FIG. 13, it can be seen that the use of diphenyl ether, having no halogen substitution, as an additive also makes it difficult to ensure stability upon overcharging.

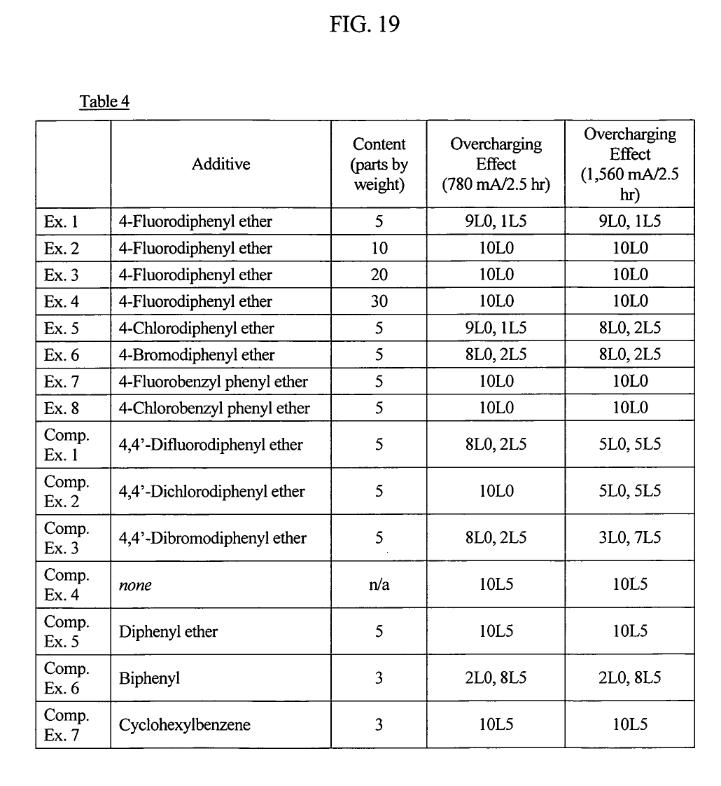

Ten (10) lithium secondary batteries for each of Examples 1 to 8 and Comparative Examples 1 to 7 were manufactured. After being charged at 4.2 V, the lithium secondary batteries were sequentially subjected to overcharging with 780 mA to 12 V, and high-rate overcharging with 1,560 mA to 12 V, i.e., the charge capacity applied during the high-rate overcharging was twice as high as the charge capacity applied during the overcharging. Upon overcharging with an electric current of 780 mA to a charge voltage of 12 V under the conditions of CC-CV for 2.5 hours, and upon high-rate overcharging with an electric current of 1,560 mA to a charge voltage of 12 V under the conditions of CC-CV for 2.5 hours, each lithium secondary battery was evaluated for stability by evaluating various properties. The results are shown in Table 4 in FIG. 19. In Table 4, the number in front of “L” is the number of the test battery. The stability of the batteries after overcharging was graded by the following scale: L0: Good; L1: Leakage; L2: Spark; L3: Smoke; L4: ignition; L5: rupture.

As shown in Table 4, batteries in Examples 1 to 8, where the halogenated diphenyl ether compound is dissolved in the non-aqueous electrolyte according to an embodiment, consumed the overcharge current. On the other hand, the battery in Comparative Example 4 used a non-aqueous electrolyte where no halogenated diphenyl ether compound is dissolved, and allowed the overcharge current to be continuously stored in an electrode therein.

The electrode of the battery in Comparative Example 4 was destabilized and reacted with the organic solution in the non-aqueous electrolyte to generate heat. The heat accelerated an increase in temperature. Although the current was shut-down, this increase in temperature was maintained, thus leading to ignition and rupture of the battery.

On the other hand, in the case of the batteries in Examples 1 to 8, where the halogenated diphenyl ether compound is added to the non-aqueous electrolyte according to an embodiment, current shut-down was expedited and a polymerization product was deposited on the surface of a positive electrode upon overcharging.

The polymerization product serves as a current bridge between a positive electrode and a negative electrode to form a fine short-circuit, thereby allowing a current to flow, and enabling a predetermined voltage to be maintained. As a result, the temperature stabilizes, thereby stabilizing the lithium secondary battery during overcharging. In addition, the occurrence of the fine short-circuit, after current cut-off, contributes to a reduction in heat generation, owing to a low voltage in spite of the current flow. During overcharging of the battery, the oxidation of the halogenated diphenyl ether compound involves overcharge current consumption and heat generation. This reaction heat causes thermal decomposition of the separator. At this time, the resulting product is solid-deposited on the separator. The solid deposition shuts pores and has electric conductivity, thus causing a fine short-circuit and enabling stabilization of the battery.

The evaluations confirmed that the batteries in Examples 1 to 8 exhibited improved stability during overcharging as compared to the batteries in Comparative Examples 1 to 3.

### Evaluation for Low-Temperature Property

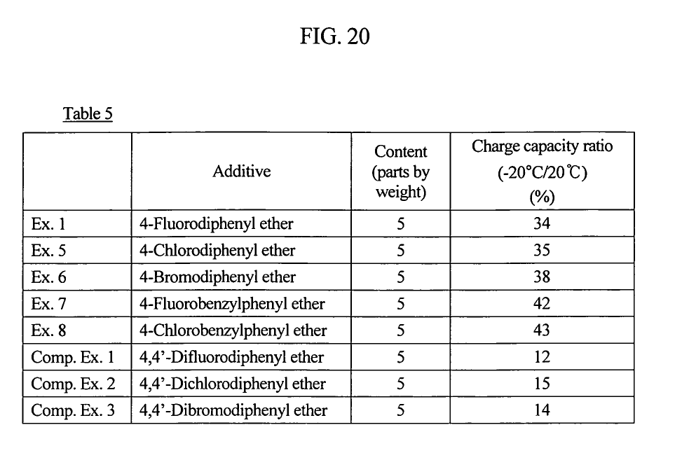

The charge capacity at both −20° C. and 20° C. was calculated for the lithium secondary batteries in Examples 1, 5, 6, 7 and 8, and Comparative Examples 1 to 3. The ratio of the charge capacity of each battery at −20° C. to the charge capacity thereof at 20° C. was determined. The results are shown in Table 5 in FIG. 20.

As can be seen from the data in Table 5, the batteries in Examples 1, 5, 6, 7 and 8 maintained a relatively high charge capacity even at a low temperature of −20° C., thereby exhibiting improved low-temperature property as compared to the batteries in Comparative Examples 1 to 3.

With respect to the low-temperature property, it is noted that the diphenyl ether compounds in Comparative Examples 1 to 3, where hydrogen of both phenyl groups is substituted by halogen, underwent a rapid increase in viscosity even at a low temperature of −20° C., whereas the batteries in Examples 1, 5, 6, 7 and 8 underwent no rapid increase in viscosity.

It will be appreciated that compounds such as biphenyl and cyclohexylbenzene undergo oxidative decomposition even at a relatively low temperature, e.g., slightly higher than 40° C., and a relatively low voltage, e.g., slightly higher than 4.4 V. A resulting product is deposited on the surface of a positive electrode. Although the battery is operated at a normal driving voltage, in the case where the battery is stored at a high temperature or partly exposed to a high voltage, the biphenyl and cyclohexylbenzene undergo oxidative decomposition, and continuously leave a deposit on the surface of the positive electrode. Accordingly, repetitive use of the battery for a long period via a series of charging and discharging thereof causes a gradual decrease in content of the biphenyl and cyclohexylbenzene in the electrolyte thereof, thus making it difficult to ensure sufficient stability upon overcharging. Thus, even if there is no overcharging, if the secondary battery is stored at a high temperature or partly exposed to a high voltage, the deposition of the biphenyl and cyclohexylbenzene on the positive electrode surface continues, thereby resulting in a great decrease in capacity of the secondary battery, and causing a deterioration in life cycle and high-temperature properties thereof.

As described herein, embodiments relate to a non-aqueous electrolyte which may enable an improvement in life cycle property and high-temperature property, as well as stability upon overcharging of a lithium secondary battery, and a lithium secondary battery comprising the non-aqueous electrolyte.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A non-aqueous electrolyte for a lithium secondary battery, comprising:
a lithium salt;
a basic organic solvent including a carbonate-based solvent; and
a halogenated diphenyl ether compound represented by Formula 1: 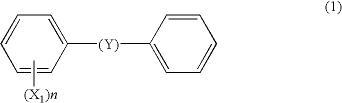
wherein, in Formula 1:
Y is —O— or —R₁—O—R₂—, where R₁ and R₂ are the same or different, and R₁ and R₂ are a C1-C5 alkyl group, an alkenyl group, or an alkoxy group, and
only one of the phenyl rings is substituted with a halogen X₁, where n is equal to 1, 2, 3, or 4 and the halogens in di-, tri-, and tetra-halogen substitutions are the same or different.

2. The electrolyte as claimed in claim 1, wherein:
one or both of the phenyl rings are substituted with one or more substituents, the substituents are the same or different, and
the substituents are a C1-C5 alkyl group, an alkenyl group, or an alkoxy group.

2. The electrolyte as claimed in claim 1, wherein the halogen X₁ is chlorine or fluorine.

3. The electrolyte as claimed in claim 1, wherein the halogenated diphenyl ether compound is chlorodiphenyl ether, fluorodiphenyl ether, bromodiphenyl ether, chlorophenyl benzyl ether, fluorophenyl benzyl ether, or a mixture thereof.

4. The electrolyte as claimed in claim 1, wherein the halogenated diphenyl ether compound is used in an amount of about 0.1 to about 20 parts by weight, based on 100 parts by weight of the basic organic solvent.

5. The electrolyte as claimed in claim 1, wherein the halogenated diphenyl ether compound is used in an amount of about 1 to about 10 parts by weight, based on 100 parts by weight of the basic organic solvent.

6. The electrolyte as claimed in claim 1, wherein the basic organic solvent is a mixture of a carbonate-based solvent and at least one of an ester-based solvent, an aromatic hydrocarbon-based solvent, or an ether-based solvent.

7. The electrolyte as claimed in claim 6, wherein:
the carbonate-based solvent includes at least one linear carbonate and at least one cyclic carbonate,
the at least one linear carbonate is dimethyl carbonate, diethyl carbonate, or methylethyl carbonate, and
the at least one cyclic carbonate is ethylene carbonate, propylene carbonate, or butylene carbonate.

8. The electrolyte as claimed in claim 6, wherein:
the basic organic solvent includes the ester-based solvent, and
the ester-based solvent is y-butyrolactone, decanolide, valerolactone, mevalonolactone, caprolactone, methyl acetate, ethyl acetate, n-propyl acetate, or a mixture thereof.

9. The electrolyte as claimed in claim 6, wherein:
the basic organic solvent includes the aromatic hydrocarbon-based solvent, and
the aromatic hydrocarbon-based solvent is fluorobenzene, 4-chlorotoluene, 4-fluorotoluene, or a mixture thereof.

10. The electrolyte as claimed in claim 6, wherein:
the basic organic solvent includes the ether-based solvent, and
the ether-based solvent is dimethyl ether, diethyl ether, dipropyl ether, dibutyl ether, or a mixture thereof.

11. The electrolyte as claimed in claim 1, wherein the lithium salt is LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₓF₂ₓ₊₁SO₂)(C_{y}F_{2y+1}SO₂) (where each of x and y is a positive integer), LiCl, LiI, or mixture thereof.

12. The electrolyte as claimed in claim 1, wherein the lithium salt is used in a concentration of about 0.6 M to about 2.0 M, based on the basic organic solvent.

13. A lithium secondary battery, comprising:
the non-aqueous electrolyte as claimed in claim 1;
an electrode part including a positive electrode and a negative electrode disposed opposite to each other; and
a separator electrically separating the positive electrode from the negative electrode.

14. The battery as claimed in claim 13, wherein a ratio of a charge capacity at −20° C. to a charge capacity at 20° C. is 0.34 or more.

15. The battery as claimed in claim 13, wherein:
the positive electrode is coated with at least one active material, and
the at least one active material is LiCoO₂, LiMnO₂, LiMn₂O₄, LiNiO₂, or LiN_{1-x-y}CoₓM_{y}O₂ (where 0≦x<1, 0≦y≦1, 0≦x+y≦1 and M is Al, Sr, Mg, or La).

16. The battery as claimed in claim 13, wherein:
the negative electrode is coated with at least one active material, and
the at least one active material is crystalline carbon, amorphous carbon, a carbon composite, a metal-carbon composite, a metal, a metal oxide, lithium metal, or a lithium alloy.

17. The battery as claimed in claim 13, wherein the separator is a polyethylene or polypropylene mono-layered separator, a polyethylene/polypropylene double-layered separator, a polyethylene/polypropylene/polyethylene triple-layered separator, or a polypropylene/polyethylene/polypropylene triple-layered separator.

18. A method of powering a device, comprising:
providing power from the positive and negative electrodes of the battery as claimed in claim 13 to power inputs of the device; and
charging the battery.

19. A method of making a non-aqueous electrolyte for a lithium secondary battery, the method comprising:
providing a lithium salt;
providing a basic organic solvent including a carbonate-based solvent;
providing a halogenated diphenyl ether compound represented by Formula 1: 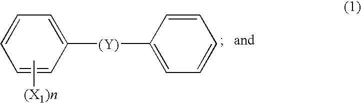
combining the lithium salt, the basic organic solvent, and the halogenated diphenyl ether compound, wherein, in Formula 1:
Y is —O— or —R₁—O—R₂—, where R₁ and R₂ are the same or different, and R₁ and R₂ are a C1-C5 alkyl group, an alkenyl group, or an alkoxy group, and
only one of the phenyl rings is substituted with a halogen X₁, where n is equal to 1, 2, 3, or 4 and the halogens in di-, tri-, and tetra-halogen substitutions are the same or different.
